(19) United States
(12) Patent Application Publication
(10) Pub. No.: US 2024/0191095 A1
(43) Pub. Date: Jun. 13, 2024

(54) CAN INNER SURFACE COATING MATERIAL AND CAN WITH COATED INNER SURFACE

(71) Applicants: Toyo Ink SC Holdings Co., Ltd., Tokyo (JP); TOYOCHEM CO., LTD., Tokyo (JP)

(72) Inventor: Tetsuya Natsumoto, Tokyo (JP)

(73) Assignees: Toyo Ink SC Holdings Co., Ltd., Tokyo (JP); TOYOCHEM CO., LTD., Tokyo (JP)

(21) Appl. No.: 18/461,020

(22) Filed: Sep. 5, 2023

(30) Foreign Application Priority Data
Dec. 9, 2022 (JP) 2022-197336

(51) Int. Cl. C09D 133/02; C09D 5/02; C09D 133/08

(52) U.S. Cl. CPC C09D 133/02; C09D 5/022; C09D 133/08

(57) ABSTRACT

The disclosure provides a can inner surface coating material for forming a coating film formed on a can inner surface, wherein the coating material suppresses degradation of the contents caused by the coating film, and improves the processability of the coating film. Specifically provided is a can inner surface coating material including a polymer (A) having carboxy groups, a compound (D) having no ethylenic unsaturated bond and having one functional group (f) capable of reacting with a carboxy group, and a liquid medium, wherein the number of functional groups (f) is less than the number of carboxy groups contained in the polymer (A).

### CROSS REFERENCE TO RELATED APPLICATIONS

This patent application claims the benefit of priority from the prior Japanese Patent Application No. 2022-197336 filed on Dec. 9, 2022, the entire contents of which are incorporated herein by reference in its entirety.

### BACKGROUND OF THE INVENTION

### Field of the Invention

The present disclosure relates to a can inner surface coating material and a can with a coated inner surface.

### Description of the Related Art

Cans including beverage cans and food cans suffer from a phenomenon in which contact between the can contents and the can inner surface can cause a deterioration in the flavor of the contents. Because these types of cans are stored with the contents contained inside, they are expected to maintain the flavor of the contents for a certain period. By using a coating material to form a coating film on the inner surface of the can, degradation in the quality of the contents caused by the can inner surface can be prevented. However, because these coating films are mainly formed from polymers, components leaching from the polymers can sometimes cause a degradation in the quality of the contents. Moreover, there is also a possibility that decay of the contents during storage may cause corrosion of the can inner surface, resulting in degradation of the can itself.

Further, in beverage cans and food cans and the like, technology that uses polymers that are very safe for the environment and humans is being developed so that even if components do leach from the coating film on the can inner surface and contaminate the contents, the effects of that leaching can be reduced.

Japanese Unexamined Patent Application Publication (Translation of PCT Application) NO. 2018-505821 (Patent Document 1) discloses, as a coating material for a beverage or food can, a coating composition having an emulsion-polymerized latex polymer substantially free of styrene that is obtained by reacting monomers including an ethylenic unsaturated polycyclic monomer and an ethylenic unsaturated monocyclic monomer having a cyclic structure with 3 to 5 atoms in the ring.

Japanese Unexamined Patent Application Publication No. 2002-155234 (Patent Document 2) discloses an aqueous resin composition for a can coating material composed of a soap-free thermosetting aqueous resin dispersion containing carboxy groups, crosslinking functional groups other than carboxy groups, aromatic cyclic groups and/or alkyl groups of 7 or more carbon atoms.

On the other hand, during the production process for a can, a method may be employed in which the opening of a one-piece molded body composed of a can body member and a bottom member is subjected to necking to match the shape of a lid member, and the lid member is then fitted to the opening. In cases such as this type of method, where the can member is subjected to processing in a state where a coating film has been formed on the inner surface of the can member, the coating film must exhibit processing conformability.

Further, in those cases where beverages or foods having a high alcohol content or beverages or foods having strong acidity are placed in a can as the can contents, the coating film formed on the can inner surface becomes more prone to corrosion. This can sometimes cause a deterioration in the taste or smell or the like of these beverages or foods.

### SUMMARY OF THE INVENTION

In food or beverage cans in which the can inner surface has been coated using the technology disclosed in Patent Document 1 and Patent Document 2, satisfactory coating film processability can sometimes not be achieved, and degradation in the quality of the contents cannot be adequately prevented by the coating film, resulting in a deterioration in the flavor of the contents such as the beverage or food.

One object of the present disclosure is to provide a can inner surface coating material for forming a coating film formed on a can inner surface, wherein the coating material suppresses degradation of the contents caused by the coating film, and improves the processability of the coating film. More specifically, one object of the present disclosure is to provide a can inner surface coating material that prevents deterioration in the flavor of the contents and improves processability of the coating film. Further, another object is to provide a can with a coated inner surface that prevents deterioration in the flavor of the contents and exhibits excellent coating film processability by using the above can inner surface coating materials.

A number of embodiments of the present invention are described below.

<1> A can inner surface coating material comprising a polymer (A) having carboxy groups, a compound (D) having no ethylenic unsaturated bond and having one functional group (f) capable of reacting with a carboxy group, and a liquid medium, wherein the number of functional groups (f) is less than the number of carboxy groups contained in the polymer (A).
<2> The can inner surface coating material according to <1>, wherein at least a portion of the polymer (A) and at least a portion of the compound (D) are included as a reaction product (E) of the polymer (A) and the compound (D).
<3> The can inner surface coating material according to <1> or <2>, wherein the polymer (A) forms a polymer emulsion.
<4> The can inner surface coating material according to any one of <1> to <3>, further comprising a polymer (B) having no carboxy group, wherein the polymer (A) and the polymer (B) form a polymer emulsion.
<5> The can inner surface coating material according to any one of <1> to <4>, further comprising a curing agent.
<6> The can inner surface coating material according to any one of <1> to <5>, wherein the polymer (A) comprises an acrylic-based polymer (A1) having carboxy groups.
<7> The can inner surface coating material according to any one of <1> to <6>, wherein the functional group (f) comprises an epoxy group, N-methylol group, isocyanate group, carbodiimide group, oxazoline group, alkoxysilyl group, silanol group, oxetane group, or β-hydroxyalkylamide group.
<8> The can inner surface coating material according to <7>, wherein the compound (D) also has a cyclic hydrocarbon structure.
<9> The can inner surface coating material according to <8>, wherein the cyclic hydrocarbon structure comprises an aromatic ring.
<10> A can with a coated inner surface, the can comprising a can member and a coating film formed on the inner surface of the can member, wherein the coating film is formed using the can inner surface coating material according to any one of <1> to <9>.
<11> The can inner surface coating material according to any one of <1> to <9>, wherein the number average molecular weight (Mn) of the polymer (A) is within a range from 4,000 to 200,000.
<12> The can inner surface coating material according to any one of <1> to <9> and <11>, wherein the number average molecular weight (Mn) of the acrylic-based polymer (A1) is within a range from 4,000 to 200,000.
<13> The can inner surface coating material according to any one of <1> to <9> and <11> to <12>, wherein the functional group (f) comprises an epoxy group, N-methylol group, isocyanate group, carbodiimide group, oxazoline group, alkoxysilyl group, silanol group, oxetane group, or β-hydroxyalkylamide group.
<14> The can inner surface coating material according to any one of <1> to <9> and <11> to <13>, further comprising a curing agent.
<15> The can inner surface coating material according to any one of <5> to <9> and <11> to <14>, wherein the curing agent comprises a phenol resin.
<16> The can inner surface coating material according to any one of <1> to <9> and <11> to <15>, wherein the compound (D) comprises an aromatic glycidyl ether.
<17> The can inner surface coating material according to any one of <1> to <9> and <11> to <16>, further comprising a polymer (B) having no carboxy group, wherein the polymer (A) and the polymer (B) form a composite polymer.
<18> The can inner surface coating material according to any one of <1> to <9> and <11> to <17>, wherein the glass transition temperature (Tg) of the coating film of the can inner surface coating material is within a range from 0° C. to 100° C.
<19> The can inner surface coating material according to any one of <1> to <9> and <11> to <18>, wherein the glass transition temperature (Tg) of the polymer (A) is within a range from −15° C. to 150° C.
<20> The can inner surface coating material according to any one of <1> to <9> and <11> to <19>, wherein the liquid medium is an aqueous liquid medium.

One embodiment of the present invention is able to provide a can inner surface coating material for forming a coating film formed on a can inner surface, wherein the coating material suppresses degradation of the contents caused by the coating film, and improves the processability of the coating film. More specifically, one embodiment of the present invention is able to provide a can inner surface coating material that prevents deterioration in the flavor of the contents and improves processability of the coating film. Further, another embodiment can provide a can with a coated inner surface that prevents deterioration in the flavor of the contents and exhibits excellent coating film processability by using these can inner surface coating materials.

### BRIEF DESCRIPTION OF THE DRAWINGS

FIG. 1 is a perspective view of a can with a coated inner surface according to one embodiment.

FIG. 2A is an explanatory diagram describing a method for evaluating the processability of coating films of the examples.

FIG. 2B is an explanatory diagram describing a method for evaluating the processability of coating films of the examples.

FIG. 2C is an explanatory diagram describing a method for evaluating the processability of coating films of the examples.

### DETAILED DESCRIPTION OF THE INVENTION

A number of embodiments of the present invention are described below. However, the present invention is not limited to the following embodiments, and the following examples in no way limit the present invention.

Before describing the present invention in further detail, some terminology is explained. The term “(meth)acrylic acid” means one or both of acrylic acid and methacrylic acid, “(meth)acrylic” means one or both of acrylic and methacrylic, and “(meth)acrylate” means one or both of acrylate and methacrylate. The term “acrylic-based polymer” means a homopolymer or copolymer of acrylic acid, methacrylic acid or a derivative of these compounds, or a copolymer of these monomers and one or more other monomers. A “coating film” is obtained by applying a coating material to a member such as a metal sheet, and describes the film obtained following the completion of crosslinking. Tg describes the glass transition temperature.

The can inner surface coating material according to one embodiment of the present invention comprises a polymer (A) having carboxy groups, a compound (D) having no ethylenic unsaturated bond and having one functional group (f) capable of reacting with a carboxy group, and a liquid medium, wherein the number of functional groups (f) is less than the number of carboxy groups contained in the polymer (A).

In the following description, sometimes the polymer (A) having carboxy groups is simply described as the polymer (A), the compound (D) having no ethylenic unsaturated bond and having one functional group (f) capable of reacting with a carboxy group is simply described as the compound (D), and the functional group (f) capable of reacting with a carboxy group is simply described as the functional group (f). Further the can inner surface coating material is also referred to as simply the coating material.

The coating material of the present disclosure is a can inner surface coating material, and can be used in a method for forming a coating film that coats the inner surface of a can. The material of the can may be a metal or a plastic or the like. The can is preferably a can used for storing a beverage or a food.

By using the can inner surface coating material of the present disclosure, degradation in the quality of the contents caused by the coating film at the can inner surface can be prevented. As a result, in those cases where the can contents are a beverage or a food, any deterioration in the flavor of the contents can be prevented. By using the can inner surface coating material of the present disclosure, the processability of the coating film can be improved. For example, in those cases where the can member is processed with the coating film already formed on the inner surface of the can member, such as in a method where necking is performed to match the opening of the can body member to the shape of the lid member, the processing conformability of the coating film can be improved. As a result, the uniformity of the coating film surface on the inner surface of the can is maintained even after processing, and any leaching of components from the coating film can be suppressed. Although not constrained by any particular theory, it is thought that one reason for this observation is that by incorporating the compound (D) together with the polymer (A) in the can inner surface coating material, the stability of the coating material is improved by the carboxy groups in the polymer (A), enabling better uniformity of the components of the coating film, and improving the durability of the coating film. Further, in the coating film formed on the can inner surface, because the functional group (f) of the compound (D) exists in a state bonded with the carboxy group of the polymer (A), the durability of the coating film, and particularly the durability relative to beverages and food and the like, can be improved, and leaching of components from the coating film can be suppressed. The coating material of the present disclosure is preferably provided in the form of a can inner surface aqueous coating material.

### <Polymer (A) Having Carboxy Groups>

The polymer (A) having carboxy groups has improved adhesion to the members to be coated as a result of having the carboxy groups, and in those cases where the coating material is to be formed as an aqueous coating material, an aqueous solution or emulsion or the like can be formed by neutralizing the carboxy groups using a cationic compound. Further, the carboxy groups of the polymer (A) function as functional groups that participate in crosslinking of the polymer. Moreover, reaction of the compound (D) described below with the carboxy groups in the polymer (A) can reduce the number of hydrophilic carboxy groups, thereby improving the retort resistance of the coating film.

Examples of the resin backbone of the polymer (A) include an acrylic-based polymer, styrene-maleic acid resin, urethane resin, or polyester resin or the like. If consideration is given to the storage stability of the coating material, then the polymer (A) is preferably an acrylic-based polymer having carboxy groups. In the following description, an acrylic-based polymer having carboxy groups is sometimes referred to as an acrylic-based polymer (A1).

The polymer (A) having carboxy groups is preferably a polymer obtained by polymerizing an ethylenic unsaturated monomer having a carboxy group, and if necessary another monomer (these monomers are jointly referred to as the ethylenic unsaturated monomer (a1), but sometimes also referred to as simply the monomer (a1)).

Further, the acrylic-based polymer (A1) having carboxy groups is more preferably a polymer obtained by polymerizing an acrylic-based monomer having a carboxy group, and if necessary another monomer (these monomers jointly represent one embodiment of the monomer (a1)). The acrylic-based monomer having a carboxy group may be at least one of (meth)acrylic acid and a (meth)acrylate having a carboxy group.

More specifically, the polymer (A) having carboxy groups may be a polymer obtained by polymerizing a monomer having a carboxy group, and at least one of a monomer having no reactive functional groups and a monomer having a reactive functional group other than a carboxy group. The polymer (A) having carboxy groups is preferably a polymer obtained by polymerizing a monomer having a carboxy group and a monomer having a reactive functional group other than a carboxy group, and an optional monomer having no reactive functional groups may also be used as desired.

Examples of the monomer having a carboxy group include (meth)acrylic acid, itaconic acid (anhydride), maleic acid (anhydride), fumaric acid, crotonic acid, α-hydroxymethylacrylic acid, 3-(acryloyloxy)propionic acid, p-vinylbenzoic acid, 2-[(meth)acryloyloxyethyl]succinic acid, 2-[(meth)acryloyloxyethyl]phthalic acid, and 2-[(meth)acryloyloxyethyl]hexahydrophthalic acid. An acid anhydride group-containing monomer produced by dehydration from two carboxy groups may also be included as a monomer having a carboxy group.

The amount of the monomer having a carboxy group included within the combined 100% by mass of the monomer (a1) is preferably at least 10% by mass, and more preferably within a range from 20 to 90% by mass.

Examples of the monomer having no reactive functional groups include alkyl (meth)acrylates such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate and ethylhexyl (meth)acrylate; and aromatic monomers such as styrene, α-methylstyrene, 3-methylstyrene and 4-methylstyrene.

Among the monomers having no reactive functional groups, the amount of alkyl (meth)acrylates included within the combined 100% by mass of the monomer (a1) is preferably within a range from 5 to 90% by mass, and more preferably from 10 to 80% by mass. By ensuring this amount is at least 5% by mass, the processability of the formed coating film can be further improved. By ensuring that this amount is not more than 90% by mass, the corrosion resistance can be further improved.

Among the monomers having no reactive functional groups, the amount of aromatic monomers included within the combined 100% by mass of the monomer (a1) is preferably within a range from 1 to 80% by mass, and more preferably from 10 to 70% by mass. By ensuring this amount is at least 1% by mass, the corrosion resistance can be further improved. By ensuring that this amount is not more than 80% by mass, the processability can be further improved.

Among the monomers having no reactive functional groups, the amount of styrene included within the combined 100% by mass of the monomer (a1) may be at least 1% by mass, at least 5% by mass, at least 10% by mass, or 30% by mass or greater. There are no particular limitations on the upper limit, but the amount of styrene may be not more than 80% by mass, not more than 70% by mass, or 50% by mass or less. By ensuring this amount is at least 1% by mass, the corrosion resistance can be further improved. By ensuring this amount is not more than 80% by mass, the processability can be further improved.

The polymer (A) may have reactive functional groups other than the carboxy groups. The term “reactive functional group” means a functional group that can react, and examples include a hydroxy group and an amino group and the like.

Examples of monomers having a reactive functional group other than a carboxy group include hydroxyalkyl (meth)acrylates such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate and hydroxyhexyl (meth)acrylate; and amide-based monomers such as N-hydroxymethyl (meth)acrylamide, N-hydroxyethyl (meth)acrylamide, N-hydroxybutyl (meth)acrylamide, N-methoxymethyl (meth)acrylamide, N-ethoxymethyl (meth)acrylamide, N-(n-,iso)butoxymethyl (meth)acrylamide, N-methoxyethyl (meth)acrylamide, N-ethoxyethyl (meth)acrylamide, N-(n-,iso)butoxyethyl (meth)acrylamide and (meth)acrylamide.

The amount of monomers having a reactive functional group other than a carboxy group included within the combined 100% by mass of the monomer (a1) is preferably within a range from 0 to 50% by mass, more preferably from 0 to 20% by mass, and even more preferably from 0.1 to 10% by mass. By ensuring this amount is not more than 50% by mass, and preferably not more than 20% by mass, the solution stability or dispersion stability of the coating material can be improved.

Synthesis of the polymer (A) may be conducted using conventional polymerization techniques such as emulsion polymerization, suspension polymerization, solution polymerization and bulk polymerization, but in the present disclosure, solution polymerization which offers easier control of the molecular weight and the reaction is preferred. In the case of solution polymerization, either an organic solvent or water may be used as the reaction solvent medium.

The number average molecular weight (Mn) of the polymer (A) is preferably within a range from 4,000 to 200,000, and more preferably from 10,000 to 100,000. By ensuring the number average molecular weight is at least 4,000, foaming of the obtained coating material can be better suppressed, and the water resistance of the formed coating film can also be improved. Further, by ensuring the number average molecular weight is not more than 200,000, the viscosity of the coating material can be more easily adjusted to a viscosity that facilitates application, and aggregates can be better reduced. An acrylic-based polymer (A1) having a number average molecular weight (Mn) of 4,000 to 200,00, and more preferably 10,000 to 100,000 is particularly desirable.

In this description, the number average molecular weight (Mn) of a polymer can be determined by conducting a measurement by gel permeation chromatography (GPC) and then referencing the measurement against standard polystyrenes.

The glass transition temperature (Tg) of the polymer (A) is preferably at least −15° C., and more preferably 5° C. or higher. There are no particular limitations on the upper limit for Tg, provided the polymer (A) functions as a high-molecular weight emulsifier during synthesis of the polymer emulsion (C) described below, but Tg is preferably not higher than 150° C., and more preferably 120° C. or lower. An acrylic-based polymer (A1) having a glass transition temperature (Tg) within a range from −15° C. to 150° C., and more preferably from 5° C. to 120° C., is particularly desirable.

The glass transition temperature (Tg) of the polymer may be a value measured by differential scanning calorimetry (DSC), or in those cases where a theoretical value can be calculated, may be a value calculated from the homo Tg values of the monomers that constitute the polymer (A) and the blend ratio between those monomers. In those cases where Tg is calculated, the FOX formula may be used.

In those cases where the coating material of the present disclosure is formed as an aqueous coating material, a basic compound is preferably used. In those cases where the coating material of the present disclosure is formed as an aqueous coating material, the basic compound is used to neutralize some or all of the carboxy groups in the polymer (A) having carboxy groups or the reaction product (E) described below. The basic compound is preferably an organic amine compound, ammonia, or an alkali metal hydroxide or the like. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine and triisopropanolamine. Examples of the alkali metal hydroxide include lithium hydroxide, sodium hydroxide, and potassium hydroxide.

The basic compound is preferably used in a ratio of 20 to 70 mol % relative to 100 mol % of the carboxy groups in the polymer (A) having carboxy groups. A single basic compound may be used alone, or a combination of two or more types of basic compound may be used.

<Compound (D) Having No Ethylenic Unsaturated Bond and Having One Functional Group (f) Capable of Reacting with a Carboxy Group>

The coating material of the present disclosure comprises the polymer (A) having carboxy groups, and the compound (D) having no ethylenic unsaturated bond and having one functional group (f) capable of reacting with a carboxy group. This coating material utilizes the reaction between the polymer (A) and the compound (D). Aspects of this coating material can be broadly classified into the following two aspects, although the coating material of the present invention is not limited by these aspects.

In the first aspect, at least a portion of the polymer (A) and at least a portion of the compound (D) are included in the coating material as a reaction product (E) of the polymer (A) and the compound (D). In the second aspect, the polymer (A) and the compound (D) are included in the coating material as separate compounds. A coating material composed of a mixture of the first aspect and the second aspect is also included as an aspect of the present invention. A more detailed description is provided below.

### [First Aspect]

The reaction product (E) obtained by bonding the polymer (A) and the compound (D) via the carboxy groups in the polymer (A) is prepared in advance, and this reaction product is used as one component in producing the coating material. Following synthesis of the polymer (A), the carboxy groups in the polymer (A) may be reacted with the compound (D) to obtain the reaction product (E). Alternatively, during the synthesis of the polymer (A), a component for introducing the carboxy groups ((meth)acrylic acid or the like in those cases where the polymer (A) is an acrylic-based polymer) and the compound (D) may be added as raw materials, meaning the reaction product (E) can be obtained by conducting the polymerization reaction and the addition reaction between the carboxy groups and the compound (D) in parallel. By subjecting the polymer component of the coating material containing this reaction product (E) to crosslinking, a coating film can be formed.

In either of the cases described above, it is important that the number of functional groups (f) is less than the number of carboxy groups in the polymer (A). If reaction with the compound (D) causes elimination of all of the carboxy groups, then the water compatibility of the polymer (A) or the reaction product (E) deteriorates markedly, and conversion of the coating material to an aqueous form becomes difficult. Further, there is also a reduction in the efficiency of polymer crosslinking, in which the carboxy groups participate.

### [Second Aspect]

The polymer (A) and the compound (D) are blended as the components of the coating material without first preparing the reaction product (E), and when the obtained coating material is subjected to crosslinking under heat to form a coating film, the carboxy groups in the polymer (A) react with the compound (D), and the compound (D) is introduced into the coating film by bonding with the polymer. As a result, a coating film is formed that has a structure similar to that obtained when the first aspect is employed. By using this method, the reaction product (E) need not be prepared in advance, which offers an advantage in terms of the steps required.

In the second aspect, in a similar manner to the first aspect, it is important that the number of functional groups (f) is less than the number of carboxy groups in the polymer (A). If the number of functional groups (f) is equal to, or exceeds, the number of carboxy groups in the polymer (A), then this causes a reduction in the efficiency of polymer crosslinking, in which the carboxy groups participate.

In both the first aspect and the second aspect described above, the existence of carboxy groups in the coating material state means that the water solubility or water dispersibility of the polymer component improves, whereas in the formed coating film, the existence of the compound (D) bonded to the polymer improves the water resistance.

Examples of the functional group (f) capable of reacting with a carboxy group include an epoxy group, N-methylol group, isocyanate group, carbodiimide group, oxazoline group, alkoxysilyl group, silanol group, oxetane group, and (3-hydroxyalkylamide group.

One preferred embodiment of the functional group (f) is an epoxy group. Epoxy groups are preferred, because they can react selectively with carboxy groups, even, for example, in the presence of hydroxy groups. Moreover, among epoxy groups, a glycidyl group is particularly preferred in terms of reactivity.

The compound (D) is a compound that has one functional group (f) per molecule. Further, the compound (D) is a compound that has no ethylenic unsaturated bond. Also, the functional group (f) of the compound (D) preferably reacts selectively with a carboxy group of the polymer (A). In the coating material, either one type, or two or more types, of the compound (D) may be included. In those cases where two or more types of the compound (D) are included in the coating material, the functional groups (f) in the two or more types of the compound (D) may be all the same, or some or all of them may be different.

The compound (D) preferably also has a cyclic hydrocarbon structure. By ensuring the compound (D) has a cyclic hydrocarbon structure in addition to the functional group (f), the scratch resistance of the formed coating film is further improved. Examples of the cyclic hydrocarbon structure include cycloalkanes and aromatic rings and the like. In terms of further increasing the hardness of the coating film, the cyclic hydrocarbon structure in the compound (D) is preferably an aromatic ring. Examples of aromatic rings that may be incorporated in the compound (D) include a benzene ring and a naphthalene ring. An aromatic glycidyl ether is particularly preferred as the compound (D).

Examples of the compound include aliphatic glycidyl ethers such as ethyl glycidyl ether, butyl glycidyl ether, tert-butyl glycidyl ether, 2-ethylhexyl glycidyl ether, dodecyl glycidyl ether, tetradecyl glycidyl ether, stearyl glycidyl ether, and glycidyl hexadecyl ether; aromatic glycidyl ethers such as benzyl glycidyl ether, phenyl glycidyl ether, cresyl glycidyl ether, glycidyl 4-methoxyphenyl ether, 4-tert-butylphenyl glycidyl ether, 2-nonylphenyl glycidyl ether, glycidyl trityl ether, o-phenylphenol glycidyl ether, 2,4-dibromophenyl glycidyl ether, and 2-naphthyl glycidyl ether; single terminal epoxy-modified silicones such as X-22-173BX (manufactured by Shin-Etsu Silicones, Inc.); monoglycidylamines such as glycidyltrimethylammonium chloride and N-glycidylphthalimide; monoepoxyalkanes such as 1,2-epoxyhexane, 1,2-epoxyoctane, 1,2-epoxydecane, 1,2-epoxydodecane, 1,2-epoxytetradecane, 1,2-epoxyhexadecane, and 1,2-epoxyoctadecane; alicyclic monoepoxy compounds such as bis(2-ethylhexyl) 4,5-epoxycyclohexane-1,2-dicarboxylate and 2-ethylhexyl 3,4-epoxycyclohexane-1-carboxylate; aromatic monoepoxy compounds such as styrene oxide and α-methylstyrene oxide; N-methylol compounds such as N-(hydroxymethyl)phthalimide; isocyanate compounds such as butyl isocyanate, cyclohexyl isocyanate, and phenyl isocyanate; carbodiimide compounds such as N,N′-diisopropylcarbodiimide, N,N′-dicyclohexylcarbodiimide, and bis(2,6-diisopropylphenyl)carbodiimide; oxazoline compounds such as 2,4,4-trimethyl-2-oxazoline, (S)-4-tert-butyl-2-(2-pyridyl)oxazoline, and 2-phenyl-(2-oxazoline); alkoxysilyl compounds such as methyltrimethoxysilane and phenyltriethoxysilane; silanol compounds such as triethylsilanol and triphenylsilanol; oxetane compounds such as 3-ethyl-3-hydroxymethyloxetane and 2-ethylhexyloxetane; and β-hydroxyalkylamides such as N-(2-hydroxyethyl)acetamide, N-methyl-N-(2-hydroxyethyl)acetamide, N-ethyl-N-(2-hydroxyethyl)acetamide, N-butyl-N-(2-hydroxyethyl)acetamide, N-(2-hydroxyethyl)propionamide, N-(2-hydroxyethyl)lactamide, N-(2-hydroxyethyl)lauramide, N-(2-hydroxyethyl)benzamide, 1-(2-hydroxyethyl)-2-pyrrolidone, and N-(2-hydroxyethyl)phthalimide.

Among these compounds, as a result of the requirements outlined above, the use of butyl glycidyl ether, phenyl glycidyl ether, or o-phenylphenol glycidyl ether is preferred, and phenyl glycidyl ether or o-phenylphenol glycidyl ether is particularly preferred.

Because the compound (D) has one functional group (f) capable of reacting with a carboxy group, the number of functional groups (f) contained in the compound (D) is preferably less than 1 mol per 1 mol of carboxy groups contained in the polymer (A). For example, the number of functional groups (f) contained in the compound (D), per 1 mol of carboxy groups contained in the polymer (A), is preferably within a range from 0.003 to 0.7 mol. This molar ratio is more preferably within a range from 0.01 to 0.4 mol, and even more preferably from 0.02 to 0.2 mol.

### <Polymer Emulsion (C)>

In the coating material of the present disclosure, the polymer (A) having carboxy groups preferably forms a polymer emulsion. This aspect includes the case where, in the coating material, the reaction product (E) of the polymer (A) and the compound (D) forms an emulsion.

More specifically, the polymer (A) having carboxy groups or the reaction product (E) is preferably dispersed in a liquid medium such as water, either alone or in combination with one or more other components, to form a polymer emulsion (C). By conducting dispersion in an aqueous liquid medium containing water, the amount of volatile organic solvent used in the coating material can be reduced and the environmental impact can be reduced compared with the case of an organic solvent solution coating material. In this description, an aqueous liquid medium means either water by itself, or a mixed liquid of water and a hydrophilic organic solvent.

In one preferred aspect, the polymer (A) having carboxy groups or the reaction product (E) may be complexed with a polymer (B) having no carboxy groups to form the polymer emulsion (C). The polymer (B) having no carboxy groups is a different polymer from the polymer (A). In the following description, the polymer (B) having no carboxy groups is also referred to as simply the polymer (B).

For example, the polymer (B) may be an acrylic-based polymer, a styrene-(meth)acrylic copolymer, or a bisphenol A epoxy resin or the like, provided the polymer contains no units having a carboxy group. Although the polymer (B) has no carboxy groups, the polymer may contain a reactive functional group other than a carboxy group. Examples of reactive functional groups that may be included in the polymer (B) include epoxy groups, hydroxy groups and amino groups.

One example of the polymer (B) can be obtained by polymerizing either one, or two or more, ethylenic unsaturated monomers having no carboxy group. In the following description, an ethylenic unsaturated monomer having no carboxy group used in the polymerization reaction for the polymer (B) is sometimes referred to as the monomer (b). The monomer (b) may be selected appropriately from among those monomers having no carboxy group mentioned above for the monomer (a1).

Further, the polymer (A) and the polymer (B) may form a core-shell polymer. The polymer (A) may be the core, with the polymer (B) forming the shell, or the polymer (B) may be the core, with the polymer (A) forming the shell. Preferably, by employing a structure in which the polymer (B) is the core and the polymer (A) forms the shell, the carboxy groups of the polymer (A) are able to further improve the stability of the coating material in an aqueous liquid medium. Further, the components are more uniform in the obtained coating material, and the durability of the coating film can be further improved.

More specifically, various types of the polymer emulsion (C) can be obtained, for example, using the types of methods described below. The coating material of the present invention is not limited to coating materials in which the polymer emulsion (C) is produced using one of the following methods.

### <Polymer Emulsion (C-1)>

A polymer emulsion (C-1) can be obtained by polymerizing the monomer (b) in the presence of an aqueous liquid medium and the polymer (A), and then conducting a neutralization as necessary.

The polymer emulsion (C-1) can be used in the second aspect described above.

### <Polymer Emulsion (C-2)>

A polymer emulsion (C-2) can be obtained by polymerizing the monomer (b) in the presence of an aqueous liquid medium and the reaction product (E), and then conducting a neutralization as necessary.

In a separate method, the polymer emulsion (C-2) can be obtained by polymerizing the monomer (b) in the presence of an aqueous liquid medium, the polymer (A) and the compound (D), so that the polymerization reaction of the monomer (b) and the addition reaction between the polymer (A) and the compound (D) proceed in parallel, thus producing the reaction product (E), and then conducting a neutralization as necessary.

The polymer emulsion (C-2) can be used in the first aspect described above.

### <Polymer Emulsion (C-3)>

A polymer emulsion (C-3) can be obtained by polymerizing the monomer (a1) in the presence of an aqueous liquid medium and the polymer (B) to produce the polymer (A), and then conducting a neutralization as necessary.

The polymer emulsion (C-3) can be used in the second aspect described above.

### <Polymer Emulsion (C-4)>

A polymer emulsion (C-4) can be obtained by polymerizing the monomer (a1) in the presence of an aqueous liquid medium, the polymer (B) and the compound (D), so that the polymerization reaction of the monomer (a1) and the addition reaction between the carboxy groups derived from the monomer (a1) and the compound (D) proceed in parallel, thus producing the reaction product (E), and then conducting a neutralization as necessary.

The polymer emulsion (C-4) can be used in the first aspect described above.

Of the above emulsions, the polymer emulsion (C-1) and the polymer emulsion (C-2) can be used favorably in the present disclosure. These emulsions are core-shell polymer emulsions, and in the polymer emulsion (C-1), the polymer (A) forms the shell. In the polymer emulsion (C-2), the reaction product (E) forms the shell. In the polymer emulsion (C-1) and the polymer emulsion (C-2), the polymer (B) that represents the polymer of the monomer (b) forms the core.

The above shell functions as a high-molecular weight emulsifier, and contributes to the dispersion stability of composite polymer particles.

When obtaining the polymer emulsion (C-1) and the polymer emulsion (C-2), a monomer having a carboxy group is not used as the monomer (b). Accordingly, because the shell composed of the polymer (A) or the reaction product (E) functions as a high-molecular weight emulsifier, the composite polymer particles can be dispersed stably within the aqueous liquid medium, even though the polymer (B) formed from a polymer of the monomer (b) has no carboxy groups,

The polymerization used for obtaining the polymer emulsion (C-1) and the polymer emulsion (C-2) may be conducted as an emulsion polymerization. For example, an emulsion polymerization may be conducted by using the polymer (A) or reaction product (E) that has been neutralized with a basic compound together with the aqueous liquid medium, emulsifying the monomer (b) to produce a monomer emulsion, and then supplying this monomer emulsion to the reaction vessel containing the aqueous liquid medium. At this time, using a mixed liquid of water and a hydrophilic organic solvent as the aqueous liquid medium can sometimes facilitate the emulsification of the monomer (b).

In a separate method, the aqueous liquid medium, the polymer (A) or the reaction product (E), and if necessary a basic compound may be introduced into the reaction vessel, and the monomer (b) then supplied to the reaction vessel and an emulsion polymerization conducted.

If a non-hydrophilic organic solvent exists during the emulsion polymerization, then the physical properties of the formed coating film tend to deteriorate. Accordingly, in those cases where the polymer (A) having carboxy groups or reaction product (E) is obtained by solution polymerization, it is preferable that a reduced pressure method or the like is used to remove the non-hydrophilic organic solvent by distillation prior to use in the emulsion polymerization of the ethylenic unsaturated monomer (b).

In the emulsion polymerization, the amount used of the polymer (A) having carboxy groups or reaction product (E) is preferably within a range from 10 to 200 parts by mass, and more preferably from 20 to 100 parts by mass, per 100 parts by mass of the monomer (b). By ensuring that the amount of the polymer (A) having carboxy groups or reaction product (E) is at least 10 parts by mass, emulsification of the monomer (b) becomes easier. Further, by ensuring the amount of the polymer (A) having carboxy groups or reaction product (E) is not more than 200 parts by mass, the water resistance of the formed coating film can be further improved.

The coating material of the present disclosure may also contain a curing agent. Examples of the curing agent include phenol resins, amino resins, polyvinyl alcohol, and derivatives of these substances. Among these, a phenol resin, amino resin, or combination thereof is preferred.

The coating material of the present disclosure may contain a phenol resin. The phenol resin functions as a curing agent that reacts with the reactive functional groups such as carboxy groups and hydroxy groups of at least one of the polymer (A) and the reaction product (E), and as a self-crosslinking component.

The phenol resin is preferably a compound obtained by reacting a polyfunctional phenol compound and an aldehyde in the presence of an alkali catalyst.

Examples of the polyfunctional phenol compound include trifunctional phenol compounds such as phenol, m-cresol and 3,5-xylenol; and difunctional phenol compounds such as o-cresol, p-cresol and p-tert-butylphenol.

The aldehyde is preferably formaldehyde or the like.

The coating material of the present disclosure may contain an amino resin. In a similar manner to the phenol resin described above, the amino resin undergoes self-crosslinking, and also functions as a curing agent that reacts with the carboxy groups of at least one of the polymer (A) having carboxy groups and the reaction product (E).

Examples of the amino resin include compounds obtained by conducting an addition reaction between an amino group-containing compound such as urea, melamine or benzoguanamine, and formaldehyde.

In those cases where the phenol resin or amino resin or the like is a compound that has been synthesized using formaldehyde, some or all of the methylol groups produced by the addition of formaldehyde are preferably etherified with an alcohol of 1 to 12 carbon atoms. This enables the stability of the phenol resin or amino resin or the like in the coating material to be further improved.

In those cases where a phenol resin is used, the amount of the phenol resin relative to 100% by mass of the total resin non-volatile fraction within the coating material is preferably within a range from 0.1 to 20% by mass, and more preferably from 1 to 15% by mass. In those cases where an amino resin is used, the amount of the amino resin by itself, or the combined amount of the amino resin and the phenol resin, expressed relative to 100% by mass of the total resin non-volatile fraction within the coating material, is preferably within a range from 0.1 to 20% by mass.

The coating material of the present disclosure may also contain an acid catalyst. By including an acid catalyst in the coating material, the hardness of the coating film can be further increased.

Examples of the acid catalyst include dodecylbenzenesulfonic acid, methanesulfonic acid, p-toluenesulfonic acid, dinonylnaphthalenedisulfonic acid, trifluoromethanesulfonic acid, phosphoric acid and sulfuric acid, as well as neutralized products of these acids.

The acid catalyst is preferably added in an amount within a range from 0.001 to 5 parts by mass per 100 parts by mass of the total resin non-volatile fraction within the coating material. By using at least 0.001 parts by mass of the acid catalyst, the crosslinking properties of the coating film can be further improved. Further, by ensuring the amount of the acid catalyst is not more than 5 parts by mass, in those cases where the coating material of the present disclosure is used as the inner surface coating material for a food or beverage can, flavor degradation of the contents due to leaching can be better suppressed.

The coating material of the present disclosure may, if necessary, also contain a lubricant such as a wax. By including a lubricant in the coating material, for example, scratching of the coating film during the can production process can be more easily prevented.

Examples of the lubricant include natural waxes such as carnauba wax, lanolin wax, palm oil, candelilla wax and rice wax; petroleum-based waxes such as paraffin wax, microcrystalline wax and petrolatam; and synthetic waxes such as polyolefin wax, and Teflon (a registered trademark) wax.

The coating material of the present disclosure may also contain a hydrophilic organic solvent for the purpose of improving the coating properties.

Examples of the hydrophilic organic solvent include various glycol monoethers or diethers such as ethylene glycol monomethyl ether, ethylene glycol dimethyl ether, ethylene glycol monoethyl ether, ethylene glycol diethyl ether, ethylene glycol mono(iso)propyl ether, ethylene glycol di(iso)propyl ether, ethylene glycol mono(iso)butyl ether, ethylene glycol di(iso)butyl ether, ethylene glycol mono-tert-butyl ether, ethylene glycol monohexyl ether, 1,3-butylene glycol 3-monomethyl ether, 3-methoxybutanol, 3-methyl-3-methoxybutanol, diethylene glycol monomethyl ether, diethylene glycol dimethyl ether, diethylene glycol monoethyl ether, diethylene glycol diethyl ether, diethylene glycol mono(iso)propyl ether, diethylene glycol di(iso)propyl ether, diethylene glycol mono(iso)butyl ether, diethylene glycol di(iso)butyl ether, diethylene glycol monohexyl ether, diethylene glycol dihexyl ether, triethylene glycol dimethyl ether, propylene glycol monomethyl ether, propylene glycol monoethyl ether, propylene glycol mono(iso)propyl ether, propylene glycol mono(iso)butyl ether, propylene glycol dimethyl ether, propylene glycol diethyl ether, propylene glycol di(iso)propyl ether, propylene glycol di(iso)butyl ether, dipropylene glycol monomethyl ether, dipropylene glycol monoethyl ether, dipropylene glycol mono(iso)propyl ether, dipropylene glycol mono(iso)butyl ether, dipropylene glycol dimethyl ether, dipropylene glycol diethyl ether, diethylene glycol di(iso)propyl ether, and dipropylene glycol di(iso)butyl ether; alcohols such as ethanol, n-propanol, isopropanol, n-butyl alcohol, isobutyl alcohol, n-amyl alcohol, isoamyl alcohol, methylamyl alcohol, octanol, and 2-ethylhexanol; ketones such as methyl ethyl ketone, dimethyl ketone, and diacetone alcohol; glycols such as ethylene glycol, diethylene glycol, propylene glycol, and dipropylene glycol; and alkoxy esters such as ethylene glycol monomethyl ether acetate, ethylene glycol monoethyl ether acetate, 1-methoxy-2-propyl acetate, and propylene glycol monomethyl ether acetate. A single hydrophilic organic solvent may be used alone, or a combination of two or more such solvents may be used.

In order to improve the coating properties, the coating material of the present disclosure may contain, as optional components, various auxiliary agents such as hydrophobic organic solvents, surfactants and antifoaming agents.

The glass transition temperature (Tg) of the coating film of the present disclosure is preferably within a range from 0° C. to 100° C., and more preferably from 0° C. to 70° C. By ensuring the coating film has a Tg of at least 0° C., the formed coating film is more resistant to scratching. Further, by ensuring the coating film has a Tg of not more than 100° C., the processability of the coating film can be further improved.

The glass transition temperature (Tg) of the coating film is a value measured using a differential scanning calorimeter (DSC). Specifically, Tg of the coating film is measured using a DSC under the conditions described below. An apparatus from TA Instruments, Inc. may be used for the DSC.
(i) The coating film is scraped off, an aluminum pan containing a weighed amount of about 5 mg of this coating film and an empty aluminum pan as a reference are set in the DSC measurement holders, the temperature is lowered from room temperature to −100° C. under a stream of nitrogen, and following completion of this temperature reduction, the temperature is held for 5 minutes.
(ii) Subsequently, the temperature is raised from −100° C. to 250° C. at a rate of temperature increase of 10° C./minute, and following completion of this temperature raising, the temperature is held for 5 minutes.
(iii) Next, the temperature is once again cooled to −100° C., and following completion of the temperature reduction, the temperature is held for 5 minutes.
(iv) Subsequently, the temperature is once again raised from −100° C. to 250° C. at a rate of temperature increase of 10° C./minute, and following completion of the temperature raising, the temperature is held for 5 minutes. In the resulting DSC curve, the temperature at the point of intersection between the low-temperature side baseline of the endothermic phenomenon and the tangent at the point of inflection is deemed the glass transition temperature (Tg).

The coating material of the present disclosure can be used in a method for forming a coating film on the inner surface of a can. The can may include, for example, the can body member, the bottom member and/or the lid member and the like. The can may be a structure inside which contents are placed, and which may then be sealed and stored. The contents may be any of a beverage, food, daily commodity, or industrial item or the like, but the coating material of the present disclosure is particularly suited to use with a beverage or food. The contents may be a solid such as a powder, granules or lumps, a liquid, a gel, a paste-like substance, or a combination thereof, but the coating material of the present disclosure is suited to liquid or gel-like beverages or food, past-like food, or wet food that contains moisture. The coating material of the present disclosure is preferably provided as a beverage can inner surface coating material or a food can inner surface coating material, and is more preferably provided as a beverage can inner surface coating material.

The coating material of the present disclosure is applied to the inner surface of a can, and may be applied at least partially to at least one member among the can body member, the bottom member, and the lid member and the like. The coating material of the present disclosure may be applied to all the inner surfaces of the can.

There are no particular limitations on the material of the can, which may be either a metal, a plastic, or a composite material thereof. The metal used for the can material is preferably a metal sheet such as an aluminum sheet, tin-plated steel sheet, chrome-treated steel sheet, or nickel-treated steel sheet. Moreover, these metal sheets may also be subjected to a surface treatment such as a zirconium treatment or a phosphate treatment. The plastic used for the can material is preferably a polyolefin such as polyethylene or polypropylene, or a polyester such as polyethylene terephthalate, or the like.

The coating method used for applying the coating material of the present disclosure is preferably a spray coating method such as air spraying, airless spraying or electrostatic spraying, a roller coating method, a dip coating method, or an electrodeposition coating method or the like. Among these, spray coating is particularly preferred. Following coating, crosslinking under heat is preferably performed. The heating conditions preferably involve heating at 150° C. to 280° C. for a period of about 10 seconds to 30 minutes. The thickness of the coating film is preferably within a range from 1 to 50 μm.

A can with a coated inner surface according to the present disclosure includes a can member and a coating film formed on the inner surface of that can member. The coating film is preferably a coating film formed using the can inner surface coating material of the present disclosure. The coating film formed using the coating material of the present disclosure is as described above. In this can with a coated inner surface, the coating film of the present disclosure may be formed on at least one of the can body member, the bottom member, and the lid member and the like. Further, the coating film of the present disclosure may be formed on at least some or all of the inner surface of the can member.

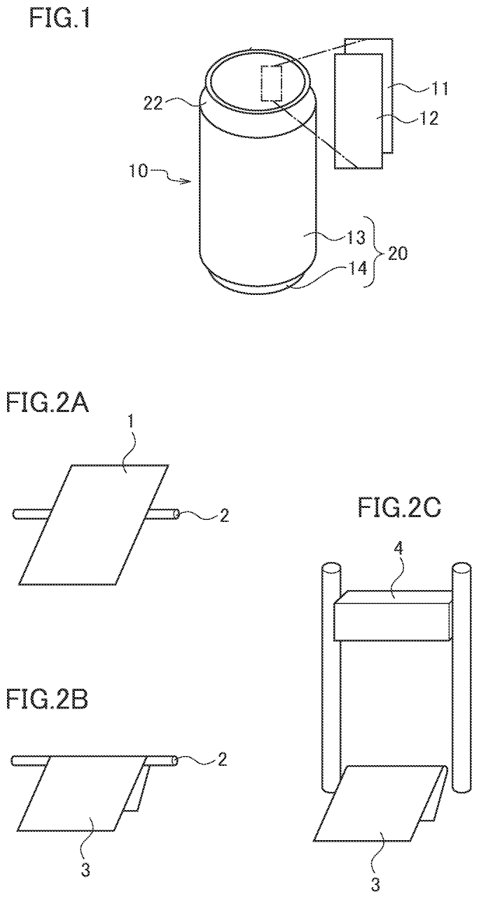

One embodiment of the can with a coated inner surface is described with reference to FIG. 1. It should be noted that the present invention is not limited to the specific examples illustrated in the drawings. In FIG. 1, 10 indicates a can with a coated inner surface, wherein the can 10 with a coated inner surface has a can member 11 and a coating film 12. The coating film 12 is formed on the inner surface of the can member 11. The can member 11 has a can body member 13 and a bottom member 14. Although not shown in the drawing, the can member 11 may also have a lid member, and the opening of the can member 11 may be sealed by the lid member. The can body member 13 and the bottom member 14 of the can member 11 are formed by one-piece molding, and a coating film may be formed on the can inner surface using the can inner surface coating material either before or after the one-piece molding. In this case, the lid member is prepared separately, and a coating film may also be formed on the can inner surface of the lid member using the can inner surface coating material. The lid member is then fitted to the opening of the can body member 13.

One example of a processing method for a can with a coated inner surface is described below using FIG. 1. First, a flat sheet-like can member is processed to produce a one-piece molded article 20 comprising the can body member 13 and the bottom member 14. Next, the can inner surface coating material is applied to the inner surface of this one-piece molded article 20 and cured to form the coating film 12. Subsequently, the region in the vicinity of the opening 21 of the one-piece molded article 20 is subjected to necking in order to match the opening 21 to the size of the lid member. The necked portion is indicated by numeral 22 in FIG. 1. Next, the lid member is fitted to the opening 21 of the one-piece molded article 20. The coating film 12 may also be formed on the inner surface of the lid member. In this structure, processing conformability of the can inner surface coating material is particularly necessary in the necked portion, but by using the can inner surface coating material according to an embodiment of the present invention and a coating film formed using that coating material, improved processing conformability can be achieved even in the necked portion.

By employing the present disclosure, a product can be provided that include the can with a coated inner surface, and a beverage or food contained inside the can with a coated inner surface. In this product, the can may be sealed with the beverage or food contained inside the can.

### EXAMPLES

The present invention is described below in further detail using a series of examples, but the present invention is not limited to these examples. In the examples, “parts” indicates “parts by mass”, and “%” indicates “% by mass”. The number average molecular weight values were determined by measurement using gel permeation chromatography (GPC) and subsequent reference against standard polystyrenes.

Formulations of the polymer (A) are shown in Table 1. Of these polymers (A), the polymer (A-3), polymer (A-5) and polymer (A-8) are provided as reaction products (E). Formulations of coating materials and evaluation results for those coating materials are shown in Table 2. In each table, the abbreviations for the compounds (D) are described below. Details are included in the procedures described below.
D-1: phenyl glycidyl ether
D-2: 2-phenyl-2-oxazoline
D-3: o-phenylphenol glycidyl ether
D-4: phenol (EO)₅ glycidyl ether
D-5: 2-ethylhexyloxetane
D-6: glycidyl 2-naphthyl ether
D-7: N-(2-hydroxyethyl)acetamide

### [Production Example 1] Synthesis of Polymer (A-1) Having Carboxy Groups

A reaction vessel fitted with a stirrer, a thermometer, a reflux condenser, a dropping funnel, and a nitrogen gas inlet tube was charged with 6.5 parts of ethylene glycol monobutyl ether and 15 parts of ion-exchanged water, heating was commenced, and the mixture was refluxed at about 100° C. With reflux maintained, a mixture of 6.8 parts of methacrylic acid, 5.1 parts of styrene, 5.1 parts of ethyl acrylate and 0.12 parts of benzoyl peroxide was added continuously in a dropwise manner from the dropping funnel over a period of two hours to perform a polymerization.

One hour after, and then two hours after completion of the dropwise addition, additional 0.03 parts of benzoyl peroxide were added, and reaction was continued for three hours from the completion of the dropwise addition.

Subsequently, 2 parts of dimethylethanolamine was added, and after stirring for 10 minutes, 59.32 parts of ion-exchanged water was added and the reaction mixture was dispersed in the water, thus obtaining a dispersion of a polymer (A-1) having carboxy groups with a non-volatile fraction of 17%.

### [Production Example 2] Synthesis of Polymer (A-2) Having Carboxy Groups

A similar reaction vessel to Production Example 1 was charged with 5.05 parts of propylene glycol methyl ether and 10 parts of butyl cellosolve, heating was commenced, and the mixture was refluxed at about 120° C. With reflux maintained, a mixture of 9.03 parts of methacrylic acid, 3.58 parts of ethyl acrylate, 6.31 parts of styrene, 1.01 parts of tert-butyl peroxyoctanoate and 4.04 parts of butyl cellosolve was added continuously in a dropwise manner from the dropping funnel over a period of three hours to perform a polymerization.

One hour after, and then two hours after completion of the dropwise addition, additional 0.03 parts of tert-butyl peroxyoctanoate were added, and reaction was continued for three hours from the completion of the dropwise addition.

Subsequently, 4.66 parts of dimethylethanolamine was added, and after stirring for 10 minutes, 56.33 parts of ion-exchanged water was added and the reaction mixture was dispersed in the water, thus obtaining a dispersion of a polymer (A-2) having carboxy groups with a non-volatile fraction of 20%.

### [Production Example 3] Synthesis of Polymer (A-3) Having Carboxy Groups

A similar reaction vessel to Production Example 1 was charged with 6.5 parts of ethylene glycol monobutyl ether, 0.5 parts of dimethylethanolamine, 0.74 parts of phenyl glycidyl ether as the compound (D), and 15 parts of ion-exchanged water, heating was commenced, and the mixture was refluxed at about 100° C. With reflux maintained, a mixture of 10.2 parts of methacrylic acid, 6.29 parts of styrene, 0.51 parts of N-butoxymethylacrylamide and 0.12 parts of benzoyl peroxide was added continuously in a dropwise manner from the dropping funnel over a period of two hours to perform a polymerization. Thereafter, the same procedure as Production Example 1 was followed to obtain a dispersion of a polymer (A-3) having carboxy groups with a non-volatile fraction of 17%.

### [Production Example 4] Synthesis of Polymer (A-4) Having Carboxy Groups

With the exception of altering the reaction temperature to 70° C., the same procedure as Production Example 1 was used to obtain a dispersion of a polymer (A-4) having carboxy groups with a non-volatile fraction of 17%.

### [Production Example 5] Synthesis of Polymer (A-5) Having Carboxy Groups

With the exceptions of using 0.74 parts of 2-phenyl-2-oxazoline as the compound (D), and using a mixture of 7.65 parts of methacrylic acid, 0.85 parts of styrene, 8.5 parts of 4-hydroxybutyl acrylate and 0.6 parts of benzoyl peroxide as the mixture added dropwise from the dropping funnel, the same procedure as Production Example 3 was used to obtain a dispersion of a polymer (A-5) having carboxy groups with a non-volatile fraction of 17%.

### [Production Example 6] Synthesis of Polymer (A-6) Having Carboxy Groups

With the exception of using a mixture of 6.8 parts of methacrylic acid, 10.2 parts of styrene and 0.6 parts of benzoyl peroxide as the mixture added dropwise from the dropping funnel, the same procedure as Production Example 1 was used to obtain a dispersion of a polymer (A-6) having carboxy groups with a non-volatile fraction of 17%.

### [Production Example 7] Synthesis of Polymer (A-7) Having Carboxy Groups

With the exception of using a mixture of 8.5 parts of methacrylic acid, 8.16 parts of α-methylstyrene, 0.34 parts of butyl acrylate and 0.16 parts of benzoyl peroxide as the mixture added dropwise from the dropping funnel, the same procedure as Production Example 1 was used to obtain a dispersion of a polymer (A-7) having carboxy groups with a non-volatile fraction of 17%.

### [Production Example 8] Synthesis of Polymer (A-8) Having Carboxy Groups

First, a mixture of 15 parts of methacrylic acid, 4.5 parts of styrene, 10.5 parts of ethyl acrylate, 1 part of o-phenylphenol glycidyl ether, 43.8 parts of 1-butanol and 1.2 parts of benzoyl peroxide was prepared. Subsequently, a similar reaction vessel to Production Example 1 was charged with ¼ of the mass of this mixture, and the mixture was heated to 85° C. With this temperature maintained, the remaining ¾ of the mass of the mixture was added dropwise from the dropping funnel over a period of two hours, and following completion of the dropwise addition, stirring was continued for a further two hours, 25 parts of ethylene glycol monobutyl ether was added, and the mixture was cooled, thus obtaining a solution of a polymer (A-8) having carboxy groups with a non-volatile fraction of 31%.

### [Production Example 9] Synthesis of Polymer (A-9) Having Carboxy Groups

With the exception of using a mixture of 15 parts of methacrylic acid, 12 parts of styrene, 2.5 parts of ethyl acrylate, 44.75 parts of 1-butanol and 0.25 parts of benzoyl peroxide, the same procedure as Production Example 8 was used to obtain a solution of a polymer (A-9) having carboxy groups with a non-volatile fraction of 30%.

The number average molecular weight (Mn) and glass transition temperature (Tg) of each of the synthesized polymers (A) having carboxy groups were measured, and are shown in Table 1. The Tg value for each polymer (A) was calculated using the FOX formula.

### [Production Example 10] Synthesis of Phenol Resin (G-1) Solution

A similar reaction vessel to Production Example 1 was charged with 500 parts of phenol, 237 parts of 37% formalin and 5 parts of oxalic acid, and the mixture was then heated to 95° C. and reacted for three hours. Subsequently, the pressure was reduced to 60 mmHg, the mixture was heated to 150° C. while a dehydration was performed, the dehydration was then continued while nitrogen gas was blown into the container, and the internal temperature was then raised to 210° C. This state was maintained for 4 hours, and a vacuum dehydration was then conducted for one hour under reduced pressure of 20 mmHg to obtain a phenol resin. Next, 200 parts of ion-exchanged water, 200 parts of a 20% aqueous solution of sodium hydroxide, and 800 parts of 37% formalin were added, and following dissolution of the above phenol resin, a reaction was conducted at 60° C. for three hours, thus obtaining a reddish brown transparent solution. Subsequently, following cooling to 40° C., 190 parts of 20% hydrochloric acid was added to this reddish brown transparent solution and stirred, and within about 10 minutes, the mixture separated into a colorless and transparent upper water layer, and a reddish brown lower organic layer. The upper layer was separated and removed by decantation, and 490 parts of n-butanol was then added to the organic layer to obtain a solution of a phenol resin (G-1) with a non-volatile fraction of 50%.

### [Production Example 11] Synthesis of Phenol Resin (G-2) Solution

A similar reaction vessel to Production Example 1 was charged with 450 parts of m-cresol, 130 parts of 86% para-formaldehyde and 250 parts of citric acid, and the mixture was then heated to 120° C. and reacted for 4 hours. Following completion of the reaction, the citric acid was removed by washing with 500 parts of ion-exchanged water. Subsequently, the pressure was reduced to 60 mmHg and a dehydration was performed, thus obtaining a phenol resin. Next, 220 parts of ion-exchanged water, 180 parts of a 20% aqueous solution of sodium hydroxide, and 700 parts of 37% formalin were added, and following dissolution of the above phenol resin, a reaction was conducted at 60° C. for three hours, thus obtaining a reddish brown transparent solution. Subsequently, following cooling to 40° C., 180 parts of 20% hydrochloric acid was added to this reddish brown transparent solution and stirred, and within about 10 minutes, the mixture separated into a colorless and transparent upper water layer, and a reddish brown lower organic layer. The upper layer was separated and removed by decantation, and 490 parts of n-butanol was then added to the organic layer to obtain a solution of a phenol resin (G-2) with a non-volatile fraction of 50%.

### [Production Example 12] Synthesis of Phenol Resin (G-3) Solution

With the exception of using p-cresol instead of m-cresol, the same procedure as Production Example 11 was used to obtain a solution of a phenol resin (G-3) with a non-volatile fraction of 50%.

### [Production Example 13] Synthesis of Phenol Resin (G-4) Solution

A similar reaction vessel to Production Example 1 was charged with 60 parts of ion-exchanged water, 60 parts of a 20% aqueous solution of sodium hydroxide, 100 parts of bisphenol A, and 300 parts of 37% formalin, and when the mixture was then heated to 60° C. and reacted for three hours, a reddish brown transparent solution was obtained. Subsequently, following cooling to 40° C., 55 parts of 20% hydrochloric acid was added to this reddish brown transparent solution and stirred, and within about 10 minutes, the mixture separated into a colorless and transparent upper water layer, and a reddish brown lower organic layer. The upper layer was separated and removed by decantation, and 140 parts of n-butanol was then added to the organic layer to obtain a solution of a phenol resin (G-4) with a non-volatile fraction of 50%.

### Example 1

A reaction vessel fitted with a stirrer, a thermometer, a reflux condenser, dropping funnels, and a nitrogen gas inlet tube was charged 18 parts of ion-exchanged water, and the water was heated to 70° C. under a nitrogen gas atmosphere with constant stirring.

Separately, a mixture of 3.07 parts of styrene, 9.93 parts of ethyl acrylate, 1.46 parts of N-butoxymethylacrylamide, and 0.67 parts of o-phenylphenol glycidyl ether as the compound (D) was emulsified using 30 parts of the dispersion of the polymer (A-1) having carboxy groups obtained in Production Example 1, and the resulting emulsion was placed in the dropping funnel 1. Further, 0.9 parts of a 1% hydrogen peroxide solution was placed in the dropping funnel 2, and 1 part of a 1% aqueous solution of sodium erythorbate was placed in the dropping funnel 3. Under constant stirring and with the temperature inside the reaction vessel maintained at 70° C., an emulsion polymerization was conducted by adding the contents of each of the dropping funnels dropwise to the reaction vessel over a period of three hours, thus obtaining a polymer emulsion.

Subsequently, 24.58 parts of ion-exchanged water, 5.3 parts of n-butanol, 4.14 parts of ethylene glycol monobutyl ether, 0.05 parts of dimethylethanolamine, 0.40 parts of the solution of the phenol resin (G-1) obtained in Production Example 10 as a curing agent, and 0.5 parts of CERACOL 79 (carnauba wax, manufactured by BYK-Chemie GmbH, non-volatile fraction: 20%) as a lubricant were added, and the resulting mixture was filtered to obtain an emulsion-type aqueous coating material (1) with a non-volatile fraction of 20%.

### Example 2

A similar reaction vessel to Example 1 was charged with 18 parts of ion-exchanged water, and the water was heated to 70° C. under a nitrogen gas atmosphere with constant stirring.

Separately, a mixture of 9.19 parts of styrene, 8.27 parts of ethyl acrylate, and 0.92 parts of N-butoxymethylacrylamide was emulsified using 40 parts of the dispersion of the polymer (A-2) having carboxy groups obtained in Production Example 2, and the resulting emulsion was placed in the dropping funnel 1. Further, 0.9 parts of a 1% hydrogen peroxide solution was placed in the dropping funnel 2, and 1 part of a 1% aqueous solution of sodium erythorbate was placed in the dropping funnel 3. Under constant stirring and with the temperature inside the reaction vessel maintained at 70° C., an emulsion polymerization was conducted by adding the contents of each of the dropping funnels dropwise to the reaction vessel over a period of three hours, thus obtaining a polymer emulsion.

Subsequently, 24.58 parts of ion-exchanged water, 0.7 parts of phenol (EO)s glycidyl ether as the compound (D), 5.3 parts of n-butanol, 4.14 parts of ethylene glycol monobutyl ether, 0.05 parts of dimethylethanolamine, 0.27 parts of the solution of the phenol resin (G-2) obtained in Production Example 11, and 0.3 parts of CERACOL 79 were added, and the resulting mixture was filtered to obtain an emulsion-type aqueous coating material (2) with a non-volatile fraction of 24%.

### Example 3

With the exceptions of using an emulsion prepared by emulsifying a mixture of 13.25 parts of styrene, 5.11 parts of ethyl acrylate and 0.57 parts of N-butoxymethylacrylamide with 26 parts of the dispersion of the polymer (A-3) having carboxy groups obtained in Production Example 3, and then adding 2 parts of the solution of the phenol resin (G-3) obtained in Production Example 12 as a curing agent and 0.12 parts of CERACOL 79 as a lubricant, the same procedure as Example 1 was used to obtain an emulsion-type aqueous coating material (3) with a non-volatile fraction of 24%.

### Example 4

With the exceptions of using an emulsion prepared by emulsifying a mixture of 10.85 parts of styrene, 3.47 parts of ethyl acrylate and 0.14 parts of N-butoxymethylacrylamide with 30 parts of the dispersion of the polymer (A-4) having carboxy groups obtained in Production Example 4, and then adding 0.35 parts of 2-phenyl-2-oxazoline as the compound (D), 0.6 parts of the solution of the phenol resin (G-1) obtained in Production Example 10 and 0.6 parts of the solution of the phenol resin (G-3) obtained in Production Example 12 as curing agents, and 0.12 parts of CERACOL 79 as a lubricant, the same procedure as Example 2 was used to obtain an emulsion-type aqueous coating material (4) with a non-volatile fraction of 22%.

### Example 5

With the exceptions of using an emulsion prepared by emulsifying a mixture of 2.41 parts of styrene, 8.43 parts of ethyl acrylate and 0.55 parts of N-butoxymethylacrylamide with 50 parts of the dispersion of the polymer (A-5) having carboxy groups obtained in Production Example 5, and then adding 2 parts of the solution of the phenol resin (G-2) obtained in Production Example 11 and 2 parts of the solution of the phenol resin (G-3) obtained in Production Example 12 as curing agents, and 2.3 parts of CERACOL 79 as a lubricant, the same procedure as Example 3 was used to obtain an emulsion-type aqueous coating material (5) with a non-volatile fraction of 19%.

### Example 6

With the exceptions of using an emulsion prepared by emulsifying a mixture of 0.66 parts of styrene, 12.36 parts of butyl acrylate, 0.13 parts of N-butoxymethylacrylamide and 0.15 parts of 2-ethylhexyloxetane as the compound (D) with 41 parts of the dispersion of the polymer (A-6) having carboxy groups obtained in Production Example 6, and then adding 0.2 parts of the solution of the phenol resin (G-1) obtained in Production Example 10 and 0.2 parts of the solution of the phenol resin (G-3) obtained in Production Example 12 as curing agents, and 1.5 parts of CERACOL 79 as a lubricant, the same procedure as Example 1 was used to obtain an emulsion-type aqueous coating material (6) with a non-volatile fraction of 19%.

### Example 7

With the exceptions of using an emulsion prepared by emulsifying a mixture of 14.7 parts of styrene, 2.76 parts of ethyl acrylate, 0.92 parts of N-butoxymethylacrylamide and 0.15 parts of glycidyl 2-naphthyl ether as the compound (D) with 46 parts of the dispersion of the polymer (A-7) having carboxy groups obtained in Production Example 7, and then adding 0.8 parts of the solution of the phenol resin (G-4) obtained in Production Example 13 as a curing agent and 0.15 parts of CERACOL 79 as a lubricant, the same procedure as Example 1 was used to obtain an emulsion-type aqueous coating material (7) with a non-volatile fraction of 22%.

### Example 8

With the exceptions of using an emulsion prepared by emulsifying a mixture of 3.07 parts of styrene, 9.93 parts of ethyl acrylate and 1.46 parts of N-butoxymethylacrylamide with 30 parts of the dispersion of the polymer (A-7) having carboxy groups obtained in Production Example 7, and then adding 2 parts of N-(2-hydroxyethyl)acetamide as the compound (D), 0.4 parts of Cymel 303LF (an amino resin manufactured by Allnex Corporation, non-volatile fraction: 100%) as a curing agent, and 0.15 parts of CERACOL 79 as a lubricant, the same procedure as Example 2 was used to obtain an emulsion-type aqueous coating material (8) with a non-volatile fraction of 22%.

### Example 9

With the exceptions of using an emulsion prepared by emulsifying a mixture of 3.68 parts of styrene, 8.41 parts of ethyl acrylate, 1.05 parts of N-butoxymethylacrylamide and 0.012 parts of phenyl glycidyl ether as the compound (D) with 33 parts of the dispersion of the polymer (A-1) having carboxy groups obtained in Production Example 1, and then adding 0.4 parts of Cymel NF2000 (an amino resin manufactured by Allnex Corporation, non-volatile fraction: 50%) as a curing agent and 0.15 parts of CERACOL 79 as a lubricant, the same procedure as Example 1 was used to obtain an emulsion-type aqueous coating material (9) with a non-volatile fraction of 19%.

### Example 10

A similar reaction vessel to Example 1 was charged with 15 parts of jER1009 (a BPA epoxy resin manufactured by Mitsubishi Chemical Corporation) and 8 parts of ethylene glycol monobutyl ether, and following complete dissolution of the resin at 120° C., the temperature was lowered to 100° C., 19.5 parts of the solution of the polymer (A-8) having carboxy groups obtained in Production Example 8 and 1.1 parts of dimethylethanolamine were added, and the resulting mixture was stirred for one hour. Subsequently, the temperature was lowered to 50° C., 58.8 parts of ion-exchanged water was added dropwise over a period of 30 minutes, and then 2 parts of the solution of the phenol resin (G-4) obtained in Production Example 13 was added as a curing agent and 0.1 parts of CERACOL 79 was added as a lubricant, thus obtaining an emulsion-type aqueous coating material (10) with a non-volatile fraction of 21%.

The polymer component of this aqueous coating material is a composite polymer of an epoxy resin and an acrylic-based polymer.

### Example 11

With the exceptions of using 17 parts of jER1009, 13 parts of the solution of the polymer (A-9) having carboxy groups obtained in Production Example 9 as the polymer having carboxy groups, and 0.5 parts of the solution of the phenol resin (G-3) obtained in Production Example 12 as a curing agent, and adding 2 parts of o-phenylphenol glycidyl ether as the compound (D) at the same time as adding the CERACOL 79, the same procedure as Example 10 was used to obtain an emulsion-type aqueous coating material (11) with a non-volatile fraction of 23%.

The polymer component of this aqueous coating material is a composite polymer of an epoxy resin and an acrylic-based polymer.

### Example 12

With the exceptions of using 17 parts of jER1009, 13 parts of the solution of the polymer (A-9) having carboxy groups obtained in Production Example 9 and 0.25 parts of Cymel 303LF as a curing agent, and adding 0.06 parts of 2-ethylhexyloxetane as the compound (D) at the same time as adding the solution of the polymer (A-9), the same procedure as Example 10 was used to obtain an emulsion-type aqueous coating material (12) with a non-volatile fraction of 22%.

The polymer component of this aqueous coating material is a composite polymer of an epoxy resin and an acrylic-based polymer.

### Example 13

With the exceptions of using 17 parts of jER1009, 13 parts of the solution of the polymer (A-9) having carboxy groups obtained in Production Example 9, and 0.5 parts of the solution of the phenol resin (G-1) obtained in Production Example 10 as a curing agent, and adding 0.01 parts of N-(2-hydroxyethyl)acetamide as the compound (D) at the same time as adding the solution of the polymer (A-9), the same procedure as Example 10 was used to obtain an emulsion-type aqueous coating material (13) with a non-volatile fraction of 22%.

The polymer component of this aqueous coating material is a composite polymer of an epoxy resin and an acrylic-based polymer.

### Example 14

With the exceptions of using 17 parts of jER1009, 13 parts of the solution of the polymer (A-9) having carboxy groups obtained in Production Example 9 and 0.5 parts of the solution of the phenol resin (G-2) obtained in Production Example 11 as a curing agent, and adding 2 parts of 2-phenyl-2-oxazoline as the compound (D) at the same time as adding the solution of the polymer (A-9), the same procedure as Example 10 was used to obtain an emulsion-type aqueous coating material (14) with a non-volatile fraction of 23%.

The polymer component of this aqueous coating material is a composite polymer of an epoxy resin and an acrylic-based polymer.

### Comparative Example 1

With the exception of not adding the compound (D), the same procedure as Example 1 was used to obtain an emulsion-type aqueous coating material (15) with a non-volatile fraction of 20%.

### Comparative Example 2

With the exceptions of using an emulsion prepared by emulsifying a mixture of 4.79 parts of styrene, 6.21 parts of butyl methacrylate, 0.95 parts of glycidyl methacrylate and 0.5 parts of hexanediol diacrylate with 15.4 parts of the dispersion of the polymer (A-1) having carboxy groups obtained in Production Example 1, and then adding 1.2 parts of the solution of the phenol resin (G-3) obtained in Production Example 12 as a curing agent, the same procedure as Example 1 was used to obtain an emulsion-type aqueous coating material (16) with a non-volatile fraction of 19%.

### Comparative Example 3

With the exceptions of using an emulsion prepared by emulsifying a mixture of 6.01 parts of styrene, 4.4 parts of butyl acrylate, 3.08 parts of butyl methacrylate and 1.17 parts of glycidyl methacrylate with 31.19 parts of the dispersion of the polymer (A-1) having carboxy groups obtained in Production Example 1, and not adding any curing agent, the same procedure as Example 1 was used to obtain an emulsion-type aqueous coating material (17) with a non-volatile fraction of 20%.

### Comparative Example 4

With the exceptions of adding 0.5 parts of the solution of the phenol resin (G-1) obtained in Production Example 10 as a curing agent, but not adding the compound (D), the same procedure as Example 11 was used to obtain an emulsion-type aqueous coating material (18) with a non-volatile fraction of 22%.

### [Evaluations]

Each of the obtained aqueous coating materials was applied to an aluminum sheet of thickness 0.26 mm in an amount sufficient to achieve a coating film thickness following drying and curing of 5 μm, and a gas oven was then used to bake the coating film at an atmospheric temperature of 200° C. for two minutes, thus obtaining a test panel. The aqueous coating material and the obtained test panel were then subjected to the following evaluations. The evaluation results are shown in Table 2.

### <Glass Transition Temperature of Coating Film>

The coating film glass transition temperature was measured using a DSC (differential scanning calorimeter, manufactured by TA Instruments, Inc.) under the conditions described below.
(i) The coating film was scraped off the test panel, an aluminum pan containing a weighed amount of about 5 mg of this coating film and an empty aluminum pan as a reference were set in the DSC measurement holders, the temperature was lowered from room temperature to −100° C. under a stream of nitrogen, and following completion of this temperature reduction, the temperature was held for 5 minutes.
(ii) Subsequently, the temperature was raised from −100° C. to 250° C. at a rate of temperature increase of 10° C./minute, and following completion of this temperature raising, the temperature was held for 5 minutes.
(iii) Next, the temperature was once again lowered to −100° C., and following completion of the temperature reduction, the temperature was held for 5 minutes.
(iv) Subsequently, the temperature was once again raised from −100° C. to 250° C. at a rate of temperature increase of 10° C./minute, and following completion of the temperature raising, the temperature was held for 5 minutes. In the resulting DSC curve, the temperature at the point of intersection between the low-temperature side baseline of the endothermic phenomenon and the tangent at the point of inflection was deemed the glass transition temperature (Tg) of the coating film.

### <Foam Suppression Properties of Aqueous Coating Material>

First, 140 g of the aqueous coating material was weighed into a container with a volume of 225 mL, and a specific gravity cup (volume: 100 mL) was used to measure the mass and calculate the specific gravity. The aqueous coating material was then returned to the container, stirred for two minutes at 2,400 rpm using a Lab Disper, and following completion of the stirring, was left to stand for one minute. Subsequently, the aqueous coating material in a state containing incorporated air bubbles was poured into the specific gravity cup, the mass was measured, and the specific gravity in the state containing the incorporated air bubbles was calculated. Based on the value of the specific gravity before and after stirring, a foaming rate was calculated. The foam suppression properties of the aqueous coating material were then evaluated from this foaming rate using the following criteria.
A: less than 10% (good)
B: at least 10% but less than 20% (usable)
C: 20% or greater (not practically usable)

### <Gel Fraction of Coating Film>

A test panel was prepared with a width of 15 cm and a length of 15 cm. This test panel was then immersed for 60 minutes in methyl ethyl ketone (MEK) that was under reflux at 80° C., and the gel fraction of the coating film was calculated on the basis of the change in mass of the test panel from before to after the immersion. The gel fraction of the coating film was evaluated against the following criteria.
A: at least 95% (good)
B: at least 90% but less than 95% (usable)
C: less than 90% (not practically usable)

### <Processability of Coating Film>

A test panel was prepared with a width of 30 mm and a length of 50 mm. Next, as illustrated in FIG. 2A, the test panel 1 was affixed to a circular rod 2 with a diameter of 3 mm at a position 30 mm along the length direction, with the coating film facing outward. Then, as illustrated in FIG. 2B, the test panel 1 was folded in two around the circular rod 2, producing a test piece 3 with a width of 30 mm and a length of approximately 30 mm. Two aluminum sheets (not shown in the drawing) each having a thickness of 0.26 mm were sandwiched inside the folded portion of this folded test piece 3, and then as illustrated in FIG. 2C, a rectangular prism-shaped 1 kg weight 4 having dimensions of width 15 cm×height 5 cm×depth 5 cm was dropped onto the folded portion of the test piece 3 from a height of 40 cm, thus completely folding the test piece. The thus obtained sample was deemed the test piece 5 (not shown in the drawings).

Subsequently, the folded portion of the test piece 5 was immersed in a saline solution with a concentration of 1%. Next, a voltage of 6.0 V was applied for 4 seconds between the saline solution and a flat metal portion of the test piece 5 not immersed in the saline solution, and the electric current during this voltage application was measured. Based on the electric current value, the processability of the coating film was evaluated against the following criteria.

In those cases where the processability of the coating film is poor, the folding processed portion of the coating film tends to crack, exposing the underlying metal sheet and increasing the conductivity, resulting in a higher electric current.
A+: less than 5 mA (extremely good)
A: at least 5 mA but less than 10 mA (good)
B: at east 10 mA but less than 20 mA (usable)
C: 20 mA or higher (not practically usable)

### <Retort Resistance of Coating Film>

With the test panel immersed in water, a retort treatment was conducted in a retort oven at 125° C. for 30 minutes, and the surface state of the coating film following the retort treatment was evaluated visually. The retort resistance of the coating film was evaluated against the following criteria.
A: no change from the coating film prior to the retort treatment (good)
B: slight whitening visible, but of no practical problem (usable)
C: marked whitening or blistering visible (not practically usable)

### <Corrosion Resistance of Coating Film>

A cutter knife was used to form cross cuts in the coated surface of the test panel, and this test panel was then immersed in an aqueous solution containing 3% sodium chloride and 3% citric acid, and after 2 weeks immersion at 37° C., the surface state of the coating film was evaluated visually. The corrosion resistance of the coating film was evaluated against the following criteria.
A: no corrosion or peeling of the coating film, no change from the coating film prior to immersion (good)
B: some minor changes visible when compared with the coating film prior to immersion, but no corrosion or peeling of the coating film, and no practical problems (usable)
C: marked corrosion of the coating film or peeling of the coating film visible (not practically usable)

### <Hygiene Properties of Coating Film>

A test panel was prepared with a width of 15 cm and a length of 15 cm. With this test panel immersed in 225 mL of ion-exchanged water, a retort treatment was conducted in a retort oven at 125° C. for 30 minutes. The water following the retort treatment was analyzed using a TOC-L CPH apparatus (manufactured by Shimadzu Corporation), and the amount of total organic carbon (TOC) was measured. The TOC amount indicates the total amount of organic matter that exists in the water as an amount of carbon within the organic matter. Based on the amount of total organic carbon, the hygiene properties of the coating film were evaluated against the following criteria.
A: less than 2 ppm (good)
B: at least 2 ppm but less than 5 ppm (usable)
C: 5 ppm or higher (poor)

### <Flavor Characteristics of Coating Film>

Octanal, which is considered important due to its low sensory threshold (sensory threshold: 0.01 ppb, Bulletin of Japan Environmental Sanitation Center, No. 17, 1990) was used as a flavor standard. A test panel 1 with a coating film surface area of 500 cm² was immersed in 500 mL of a 5% ethanol aqueous solution containing 5 ppm of octanal, and the container was then sealed and left to stand at 40° C. for one week. After the one week had passed, each test panel was removed from the solution, and then washed with distilled water and re-immersed in 10 mL of carbon disulfide to extract the octanal adsorbed to the test panel, and the amount of adsorption was then quantified by gas chromatography. With the total amount of octanal contained in the immersion solution (500 mL) deemed to be 100%, an octanal adsorption rate was calculated from the amount of octanal adsorbed to the coating film, and the flavor characteristics of the coating film were then evaluated against the following criteria. A lower adsorption rate indicates superior flavor retention.
A: less than 10% (good)
B: at least 10% but less than 20% (usable)
C: 20% or higher (poor)

### <Scratch Resistance of Coating Film>

The test panel was heated to 40° C., and a Tribo Gear HEIDON-22H (manufactured by SHINTO Scientific Co., Ltd.) was used to conduct scratch measurements with the load varied continuously from 0 to 500 g, under conditions including a scratch diamond stylus of 100 μm, a scratch length of 50 mm, and a scratching speed of 300 mm/minute. The load when a scratch was generated in the coating film and that scratch penetrated through to the aluminum substrate was measured. Based on that load value, the scratch resistance of the coating film was evaluated against the following criteria.
A: load of 400 g or higher (good)
B: load of at least 200 g but less than 400 g (usable)
C: load of less than 200 g (not practically usable)

TABLE 1

| | | Production | Production | Production | Production | Production | Production | Production | Production | Production |
|---|---|---|---|---|---|---|---|---|---|---|
| | | Example 1 | Example 2 | Example 3 | Example 4 | Example 5 | Example 6 | Example 7 | Example 8 | Example 9 |
| Polymer (A) having carboxyl groups | | A-1 | A-2 | A-3 | A-4 | A-5 | A-6 | A-7 | A-8 | A-9 |
| Properties | Compound (D) | — | — | D-1 | — | D-2 | — | — | D-3 | — |
| | Number average | 92,000 | 10,000 | 11,000 | 190,000 | 30,000 | 5,000 | 70,000 | 12,000 | 90,000 |
| | molecular weight | | | | | | | | | |
| | Polymer (A) | 62.3 | 80.9 | 116.4 | 62.3 | −12.7 | 111.4 | 140.8 | 57.5 | 99.1 |
| | Tg [° C.] | | | | | | | | | |
| | calculated from | | | | | | | | | |
| | FOX formula | | | | | | | | | |

TABLE 2-1

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4 | ple 5 | ple 6 | ple 7 | ple 8 | ple 9 |
| Coating material | | (1) | (2) | (3) | (4) | (5) | (6) | (7) | (8) | (9) |
| | Polymer (A) having | A-1 | A-2 | A-3 | A-4 | A-5 | A-6 | A-7 | A-7 | A-1 |
| | carboxyl groups | | | | | | | | | |
| | Compound (D)/added | — | — | D-1 | — | D-2 | — | — | — | — |
| | during synthesis of | | | | | | | | | |
| | polymer (A) | | | | | | | | | |
| | Compound (D)/added | D-3 | — | — | — | — | D-5 | D-6 | — | D-1 |
| | during reaction of | | | | | | | | | |
| | polymer (A) and | | | | | | | | | |
| | other components | | | | | | | | | |
| | Compound (D)/added | — | D-4 | — | D-2 | — | — | — | D-7 | — |
| | to coating material | | | | | | | | | |
| | Molar ratio of functional | 0.13 | 0.15 | 0.04 | 0.01 | 0.06 | 0.2 | 0.02 | 0.655 | 0.003 |
| | groups (f) relative to | | | | | | | | | |
| | carboxyl groups in | | | | | | | | | |
| | polymer (A) | | | | | | | | | |
| Properties | Coating film | 25 | 45 | 68 | 69 | 0 | 10 | 100 | 50 | 30 |
| | Tg [° C.]/ | | | | | | | | | |
| | measured by DSC | | | | | | | | | |
| Physical | Foam suppression | A | A | A | B | B | A | A | A | A |
| properties | properties of | | | | | | | | | |
| | coating material | | | | | | | | | |
| | Gel fraction | A | A | A | A | A | A | A | B | A |
| | of coating film | | | | | | | | | |
| | Processability | A+ | A | A+ | A+ | A+ | A | B | B | A |
| | of coating film | | | | | | | | | |
| | Retort resistance | A | A | A | B | B | B | A | A | B |
| | of coating film | | | | | | | | | |
| | Corrosion resistance | A | A | A | A | A | A | B | A | B |
| | of coating film | | | | | | | | | |
| | Hygiene properties | A | A | A | A | A | A | A | B | A |
| | of coating film | | | | | | | | | |
| | Flavor characteristics | A | A | A | A | A | A | A | A | A |
| | of coating film | | | | | | | | | |
| | Scratch resistance | A | A | A | A | B | B | A | A | A |
| | of coating film | | | | | | | | | |

TABLE 2-2

| | | | | | | | Compar- | Compar- | Compar- | Compar- |
|---|---|---|---|---|---|---|---|---|---|---|
| | | | | | | | ative | ative | ative | ative |
| | | Exam- | Exam- | Exam- | Exam- | Exam- | Exam- | Exam- | Exam- | Exam- |
| | | ple 10 | ple 11 | ple 12 | ple 13 | ple 14 | ple 1 | ple 2 | ple 3 | ple 4 |
| Coating material | | (10) | (11) | (12) | (13) | (14) | (15) | (16) | (17) | (18) |
| | Polymer (A) having | A-8 | A-9 | A-9 | A-9 | A-9 | A-1 | A-1 | A-1 | A-9 |
| | carboxyl groups | | | | | | | | | |
| | Compound (D)/added | D-3 | — | — | — | — | — | — | — | — |
| | during synthesis of | | | | | | | | | |
| | polymer (A) | | | | | | | | | |
| | Compound (D)/added | — | — | D-5 | D-7 | D-2 | — | — | — | — |
| | during reaction of | | | | | | | | | |
| | polymer (A) and | | | | | | | | | |
| | other components | | | | | | | | | |
| | Compound (D)/added | — | D-3 | — | — | — | — | — | — | — |
| | to coating material | | | | | | | | | |
| | Molar ratio of functional | 0.025 | 0.39 | 0.012 | 0.004 | 0.6 | — | — | — | — |
| | groups (f) relative to | | | | | | | | | |
| | carboxyl groups in | | | | | | | | | |
| | polymer (A) | | | | | | | | | |
| Properties | Coating film | 65 | 99 | 99 | 99 | 99 | 25 | 60 | 35 | 105 |
| | Tg [° C.]/ | | | | | | | | | |
| | measured by DSC | | | | | | | | | |
| Physical | Foam suppression | A | A | A | A | A | A | B | B | A |
| properties | properties of | | | | | | | | | |
| | coating material | | | | | | | | | |
| | Gel fraction of | A | B | B | B | B | A | B | B | B |
| | coating film | | | | | | | | | |
| | Processability | B | B | B | B | B | A | C | C | B |
| | of coating film | | | | | | | | | |
| | Retort resistance | A | A | A | B | A | C | B | C | C |
| | of coating film | | | | | | | | | |
| | Corrosion resistance | A | A | A | B | A | C | C | C | B |
| | of coating film | | | | | | | | | |
| | Hygiene properties | A | A | A | A | B | A | A | B | B |
| | of coating film | | | | | | | | | |
| | Flavor characteristics | A | A | A | A | A | B | A | B | A |
| | of coating film | | | | | | | | | |
| | Scratch resistance | A | A | A | B | A | C | C | C | A |
| | of coating film | | | | | | | | | |

The present invention has been described above with reference to the embodiments, but the present invention is not limited thereto. Regarding configurations and details of the present invention, various modifications that can be understood by those skilled in the art can be made within the scope of the invention.

1. A can inner surface coating material comprising a polymer (A) having carboxy groups, a compound (D) having no ethylenic unsaturated bond and having one functional group (f) capable of reacting with a carboxy group, and a liquid medium, wherein
the number of functional groups (f) is less than the number of carboxy groups contained in the polymer (A).

2. The can inner surface coating material according to claim 1, wherein at least a portion of the polymer (A) and at least a portion of the compound (D) are included as a reaction product (E) of the polymer (A) and the compound (D).

3. The can inner surface coating material according to claim 1, wherein the polymer (A) forms a polymer emulsion.

4. The can inner surface coating material according to claim 1, further comprising a polymer (B) having no carboxy group, wherein the polymer (A) and the polymer (B) form a polymer emulsion.

5. The can inner surface coating material according to claim 1, further comprising a curing agent.

6. The can inner surface coating material according to claim 1, wherein the polymer (A) comprises an acrylic-based polymer (A1) having carboxy groups.

7. The can inner surface coating material according to claim 1, wherein the functional group (f) comprises an epoxy group, N-methylol group, isocyanate group, carbodiimide group, oxazoline group, alkoxysilyl group, silanol group, oxetane group, or β-hydroxyalkylamide group.

8. The can inner surface coating material according to claim 7, wherein the compound (D) also has a cyclic hydrocarbon structure.

9. The can inner surface coating material according to claim 8, wherein the cyclic hydrocarbon structure comprises an aromatic ring.

10. A can with a coated inner surface, the can comprising a can member and a coating film formed on the inner surface of the can member, wherein the coating film is formed using the can inner surface coating material according to claim 1.

11. The can inner surface coating material according to claim 1, wherein the number average molecular weight (Mn) of the polymer (A) is within a range from 4,000 to 200,000.

12. The can inner surface coating material according to claim 6, wherein the number average molecular weight (Mn) of the acrylic-based polymer (A1) is within a range from 4,000 to 200,000.

13. The can inner surface coating material according to claim 12, wherein the functional group (f) comprises an epoxy group, N-methylol group, isocyanate group, carbodiimide group, oxazoline group, alkoxysilyl group, silanol group, oxetane group, or β-hydroxyalkylamide group.

14. The can inner surface coating material according to claim 13, further comprising a curing agent.

15. The can inner surface coating material according to claim 14, wherein the curing agent comprises a phenol resin.

16. The can inner surface coating material according to claim 13, wherein the compound (D) comprises an aromatic glycidyl ether.

17. The can inner surface coating material according to claim 13, further comprising a polymer (B) having no carboxy group, wherein the polymer (A) and the polymer (B) form a composite polymer.

18. The can inner surface coating material according to claim 13, wherein the glass transition temperature (Tg) of the coating film of the can inner surface coating material is within a range from 0° C. to 100° C.

19. The can inner surface coating material according to claim 13, wherein the glass transition temperature (Tg) of the polymer (A) is within a range from −15° C. to 150° C.

20. The can inner surface coating material according to claim 13, wherein the liquid medium is an aqueous liquid medium.
